(19) United States
(12) Patent Application Publication
(10) Pub. No.: US 2005/0120391 A1
(43) Pub. Date: Jun. 2, 2005

(54) System and method for generation of interactive TV content

(75) Inventors: Paul D. Haynie, Atlanta, GA (US); Daniel H. Howard, Atlanta, GA (US); Richard J. Protus, Smyrna, GA (US); James D. Langford JR., Atlanta, GA (US); James R. Harrell, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: QUADROCK COMMUNICATIONS, INC., Atlanta, GA (US)

(21) Appl. No.: 11/001,941

(22) Filed: Dec. 2, 2004

Related U.S. Application Data
(60) Provisional application No. 60/526,257, filed on Dec. 2, 2003.

(51) Int. Cl. H04H 9/00; H04N 7/16; H04N 7/173

(52) U.S. Cl. 725/135; 725/138; 725/13; 725/24

(57) ABSTRACT

A system for manually and automatically generating interactive content for integration with television programming uses existing analog or digital television programming that is entirely devoid of interactive content, or can integrate legacy interactive content with fully interactive content generated automatically and/or with authoring tools in order to provide a complete interactive experience to television viewers of current and future television programming.

### CROSS REFERENCE TO RELATED APPLICATION

This application claims the benefit under 35 U.S.C. §119(e) of U.S. Provisional Patent Application Ser. No. 60/526,257 for “System and Method for Generation of Interactive TV Content,” which was filed Dec. 2, 2003, and which is incorporated herein by reference in its entirety.

### BACKGROUND OF THE INVENTION

1. Field of the Invention

The present invention relates to television, and more particularly, to a system and method for the manual and/or automatic generation of interactive content related to television programming and advertisements.

2. Related Art

Interactive television (TV) has already been deployed in various forms. The electronic program guide (EPG) is one example, where the TV viewer is able to use the remote control to control the display of programming information such as TV show start times and duration, as well as brief synopses of TV shows. The viewer can navigate around the EPG, sorting the listings, or selecting a specific show or genre of shows to watch or tune to at a later time. Another example is the WebTV interactive system produced by Microsoft, wherein web links, information about the show or story, shopping links, and so on are transmitted to the customer premise equipment (CPE) through the vertical blanking interval (VBI) of the TV signal. Other examples of interactive TV include television delivered via the Internet Protocol (IP) to a personal computer (PC), where true interactivity can be provided, but typically only a subset of full interactivity is implemented. For the purposes of this patent application, full interactivity is defined as fully customizable screens and options that are integrated with the original television display, with interactive content being updated on the fly based on viewer preferences, demographics, other similar viewer's interactions, and the programming content being viewed. The user interface for such a fully interactive system should also be completely flexible and customizable.

No current interactive TV system intended for display on present-day analog or digital televisions provides this type of fully interactive and customizable interface and interactive content. The viewer is presented with either a PC screen that is displayed using the TV as a monitor, or the interactive content on the television screen is identical for all viewers. It is therefore desirable to have a fully interactive system for current and future television broadcasting where viewers can interact with the programming in a natural manner and the interactive content is customized to the viewer's preferences and past history of interests, as well as to the interests of other, similar viewers.

A key problem limiting the ability to deliver such fully interactive content coupled to today's analog or digital TV programming is the lack of a system for quickly generating this fully interactive content, either off-line or in real or near-real time. Currently, authoring tools are used for generation of the content with no input from the TV viewer, either off line or in real time. A system that generates fully interactive and dynamically defined content that is personalized for each viewer, using a combination of authoring tools, automatic generation based on programming material, and feedback from viewers themselves, is described in this patent.

### BRIEF SUMMARY OF THE INVENTION

The present invention is directed to a method and system for generating interactive content for interactive TV that is customizable and dynamically altered in response to the TV programming and advertising, the viewer's preferences, viewer usage history, and other viewer inputs. In order to automatically generate this interactive content, a system for processing a variety of data related to the TV programming is described, with examples being existing data sent in the vertical blanking interval (including closed caption text and current interactive data packets), web sites related to the TV program or advertisements, inputs from the viewers (including remote control selections, speech, and eye movements), text in the TV screen image such as banners, titles, and information sent over similar channels (such as other news channels if a news channel is currently being watched). The interactive content generation system may be located at a central site, or at the customer premise, or both.

In one aspect of the present invention there is provided a system for capturing and processing the closed caption text data that is frequently transmitted along with television broadcasts. The entire closed caption text is processed to identify keywords that can be used by later algorithms for identifying and re-purposing data available from packet switched networks for interactive television applications. The processing algorithms include using word frequency of occurrence lists with associated dynamic occurrence thresholds to filter out the least important and most commonly occurring words from the closed caption text, using grammatical rules and structure to identify candidate key words, using manual generation of key words related to the genre of the TV program being watched and selecting those closed caption keywords which are conceptually similar or lexigraphically related to the manually generated words, or any combination of these aforementioned algorithms. The resulting keywords are combined with keywords that indicate a particular viewer's preference or profile, and the combination keywords are used to generate interactive content related to what is happening in the television program at that moment during the program by searching data available from packet-switched networks or contained on a local network. If closed caption text is unavailable in a particular program, a speech recognition system is used to generate text from the audio portion of the television broadcast.

In another aspect, there is provided a method where web sites related to the television program are searched and processed in order to generate additional interactive content for interactive TV. Key words relating to the program known ahead of time, as well as key words provided by the closed caption text, or from the viewer himself when interacting with the system are used to process candidate web sites for useful links that can be integrated into the television programming.

In another aspect, there is provided a method using image capture and optical character recognition to recognize additional text which is displayed on the screen, process that text and generate additional interactive content for the viewer. This system is also used with pattern recognition to identify objects in the television image that may become subjects of interactive applications.

In another aspect, there is provided a method using MPEG 4 and/or MPEG 7 encoding of the television broadcast in order to highlight and recognize objects in the TV image using the arbitrary shape compression feature of MPEG 4, for example. Other embodiments may use wavelet techniques, or other edge detection schemes to highlight and identify objects in a television image.

In another aspect, the interactive content is generated and customized for each viewer using the results of the aforementioned aspects, combined with viewer inputs, demographic data, viewer preferences, viewer profiles which contain keywords to be combined with the keywords determined from processing the television program itself, inputs and preferences of other viewers, advertiser goals and/or inputs, and similar data derived from other television programs or channels which relates to the currently viewed program via lexigraphy, related terms, definitions, concepts, personal interest areas, and other relationships. Importantly, either the existing two way communications channel to the customer premises, or a separate two way communications channel to the interactive television integration device, may be used for sending data to, and receiving it from, the television viewer. Two techniques for customizing the interactive content are described. The first uses computer processing of the data from the aforementioned aspects and combination with designed goals and algorithms for provision of interactive TV. This technique is used for generation of customized interactive content that is specific to individual viewers, as well as content that is common to all viewers. The second technique requires a human being to review the data produced from the aforementioned aspects and the human selects the most desirable links and interactive content to embed into the television broadcast. The human-based system generates interactive content that is common to all viewers, or at least to large groups of viewers, and also generates interactive content that is driven by advertiser or other sponsor goals.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The present invention will be described with reference to the accompanying drawings. The drawing in which an element first appears is typically indicated by the leftmost digit(s) in the corresponding reference number.

FIG. 1 illustrates an overall network diagram for provision of fully interactive television content that is integrated with existing television broadcasts or stored programming. In this figure, elements of interactive television content generation and selection are contained both in central repositories and also in the customer premise equipment.

FIG. 2 shows a system of the present invention used to automatically generate interactive television content from existing television.

FIG. 3 shows a block diagram of an interactive TV content generator for image objects and motion or actions within the television image.

FIG. 4 shows a similar interactive TV content generator for text, speech, and sounds within the television program.

FIG. 5 shows a system of the present invention used to generate, store and process interactive content in centrally located libraries that include all types of interactive content generated by the method described in this patent, and a system of the present invention used to process, rank, and select interactive content for delivery to integration devices in the customer premises as shown in FIG. 1.

FIG. 6 shows a system of the present invention for integration of interactive content with existing television material where the interactive content generator, local libraries of interactive content, and the ranking, processing, and delivery of interactive content resides in the customer premises equipment.

FIG. 7a depicts algorithms used for the generation of interactive television content when there is no access to a stored copy of the television program prior to its broadcast, and FIG. 7b depicts the algorithms used when there is access ahead of time to the entire television program for processing.

FIG. 8 depicts more detail of algorithms used to identify candidate interactive content from available content such as other episodes of the same program, similar programs, web site content, and other content associated with the television program such as sponsor content, government content, and so on.

FIG. 9 depicts the first step in FIG. 8 where content is located and ranked according to goals of the interactive television content developers, television producers, sponsors, and others without access to the entire television program.

FIG. 10 depicts algorithms for generation of interactive television content when access to the entire television program is provided during the generation process. A similar system can be used for generation of interactive television content in real time when the television program is being broadcast.

### DETAILED DESCRIPTION OF THE INVENTION

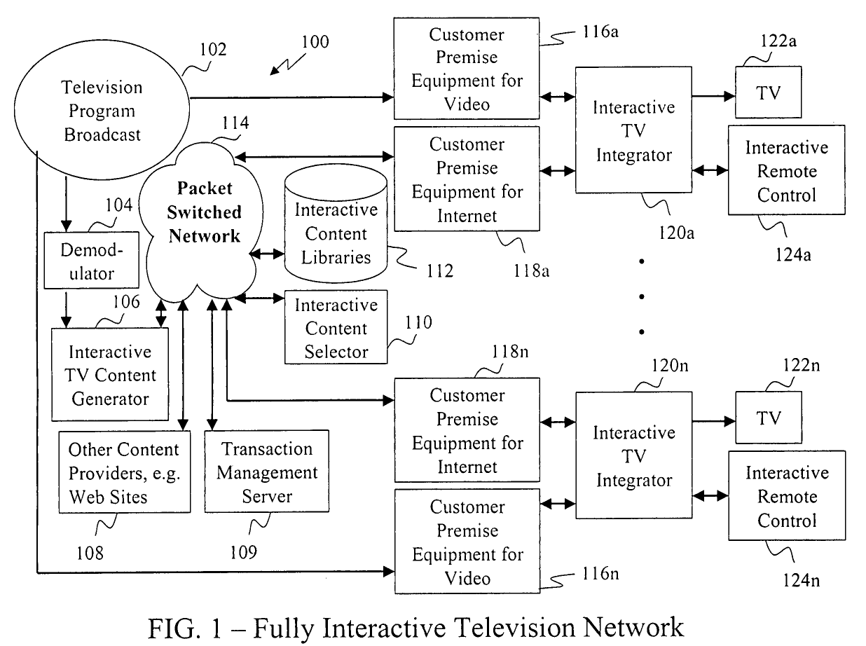

FIG. 1 shows a network 100 for provision of fully interactive television. Interactive content intended for integration with the television program and/or broadcast 102 is initially generated by the interactive TV content generator 106 and stored in the interactive content libraries 112. The interactive content generator 106 will be used prior to the broadcast or playing of a particular program to develop initial interactive content for storage in the libraries 112, and the generator 106 will also be used to generate content during the broadcast or playing of the television program. There are thus both off-line and real-time aspects to the interactive content generator. For real-time content generation, the television broadcast, which may be received via cable, satellite, off-air, or via packet switched network 114, will be demodulated by the demodulator 104 if received at radio frequency (RF), otherwise it will be received by the content generator 106 via the packet switched network 114.

The interactive content generator uses information contained in the television program, information previously stored in the interactive content libraries, and information from other content providers 108 to develop and synchronize candidate interactive television content to the television program. If the interactive content must be purchased by the viewer, and/or if the interactive content contains opportunities for purchases based on the content, then the transaction management server 109 coordinates the billing and purchases of viewers, and also provides other customer fulfillment functions such as providing coupons, special discounts and promotions to viewers. During actual broadcast or playing of the interactive television program, the interactive content selector 110 uses information from other content providers such as interactive television program sponsors, and viewer preferences, history, and group viewer preferences to select the specific interactive content which is to be associated with the television program. This interactive content can be customized for each viewer based on his or her preferences, selections during the program, or demographics. The interactive content chosen by the content selector is transmitted to the individual viewers via the packet switched network 114 and the customers' choices, preferences, and purchase particulars are also retained in the transaction management server and may be transmitted in part or in whole to interactive content providers 108 for the purpose of customer preference tracking, rewards, and customer fulfillment functions.

At the customer premise, the video reception equipment 116a receives the conventional television program, while the Internet equipment 118a receives the interactive content designed for the television program and customized for each individual viewer. The conventional video and interactive content are then integrated by the interactive TV integrator 120a for display on the customer's TV 122a and for interaction with the customer's interactive TV remote control 124. The interactive TV network simultaneously connects thusly to a plentitude of customer premises from one to n, as indicated by the customer premise equipment 116n through 124n. Thus, the interactive network shown in FIG. 1 simultaneously provides individualized interactive content to a plentitude of viewers that uses both previously developed interactive content as well as content developed during the program broadcast. The network therefore allows current television programming to be transformed into fully interactive and personalized interactive television via the devices shown in FIG. 1. The television program used for developing and delivering the interactive content may be completely devoid of any interactivity, or may include interactive content developed by other systems. This legacy interactive content will be preserved by the present invention and can be provided to the viewers if they desire.

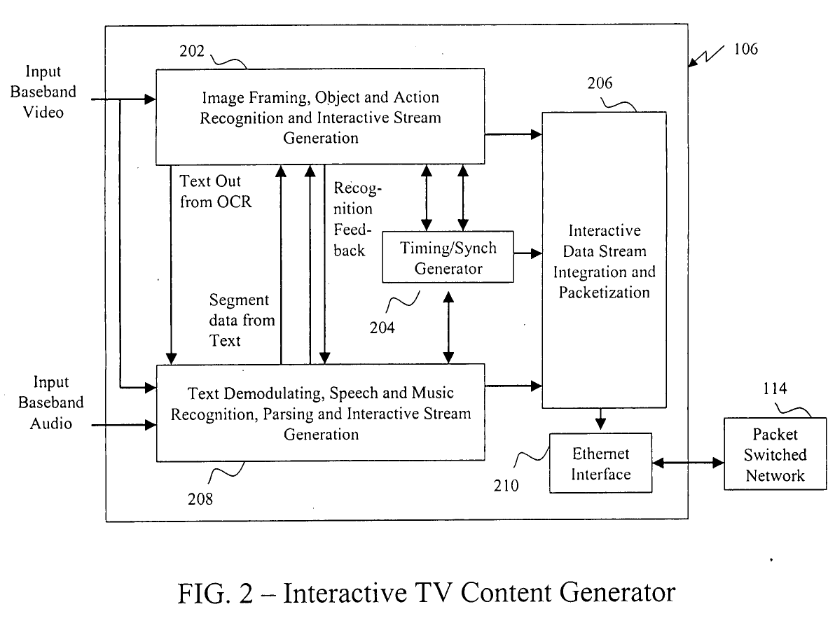

FIG. 2 depicts a block diagram of the interactive TV content generator 106 that develops interactive content streams from the television program either prior to, or during the broadcast of the television program. Typical television programs include image or frames, audio tracks, and closed caption text data sent either in the vertical blanking interval (VBI) of analog signals, or packetized in MPEG-based or other forms of digital video transmissions. These are the sources of, and pointers to,interactive television content which can be generated for the program. As an example, since closed caption text is timed to occur at specific points in the television program, the closed caption text can be used to coarsely synchronize the television program to interactive content that is related to that closed caption text. Closed caption timing information can be derived from the transmitted signal, or determined by stamping the decoded closed caption text with the system time when a television program is received. This timestamp can then be associated with interactive television content that is related to closed caption text with that timestamp, or to other data derived from the television program and timestamped such as the aforementioned speech recognition data, image and optical character recognition data, and so on. Thus, the input video and audio are processed to generate keywords with timing information that are then combined with viewer keywords to produce interactive streams that are related to, and synchronized with the television programming by the devices 202 and 208, and the timing/synch generator 204. The units 202 and 208 provide data to each other as they process the image and speech portions of the television program in order to correct and correlate the speech and image streams generated by each unit. The resulting streams are then passed to the interactive data stream integrator and packetizer 206, and are output to a packet switched network 114 via the Ethernet interface 210. The interactive stream generators 202 and 208 will be described in further detail below, however it is noted that the system shown in FIG. 2 provides a method and system for identifying all pertinent information in the television program that could be used for viewer interaction. Examples include text of speech delivered in the program, identification of sounds and/or music in the program, identification of objects in the screen such as clothes, household items, cars, and other items typically purchased by viewers, and even actions ongoing in the program such as eating, drinking, running, swimming, and so on. All speech, sounds, screen objects, and actions are potential stimulators of interactive behavior by viewers, and thus are processed and identified by the system shown in FIG. 2. Importantly, the two stream generators provide feedback to each other in order to improve the detection and classification process. This feedback is accomplished via providing initial and corrected object detections from each system to the other. For example, if the image processing system indicates a car is traveling down the road, and in the audio track of the program the word “Ferrarri” is detected, the system can make an association and develop an interactive stream for that instant of the program that includes Ferrarri sports cars. Additionally the feedback can be used to correct decisions made by either system. For example, if the closed caption text contains a miss-spelled word such as “airplxne” instead of “airplane”, if the image system detected the image of an airplane, it would provide that object detection to the audio system and the miss-spelled word can then be corrected. More typically, since image object and action recognition are much more challenging than text or speech recognition, the text and speech recognition outputs are used by the image system to improve the accuracy of image object and action recognition. For example, a coffee cup in the image which might be partially obscured in the image can be correctly classified when the text “would you like some more coffee” correlated with the list of possible objects corresponding to the obscured coffee cup image. As will be described below, the system permits context-based recognition and classification of image objects, image movements, speech, and sounds.

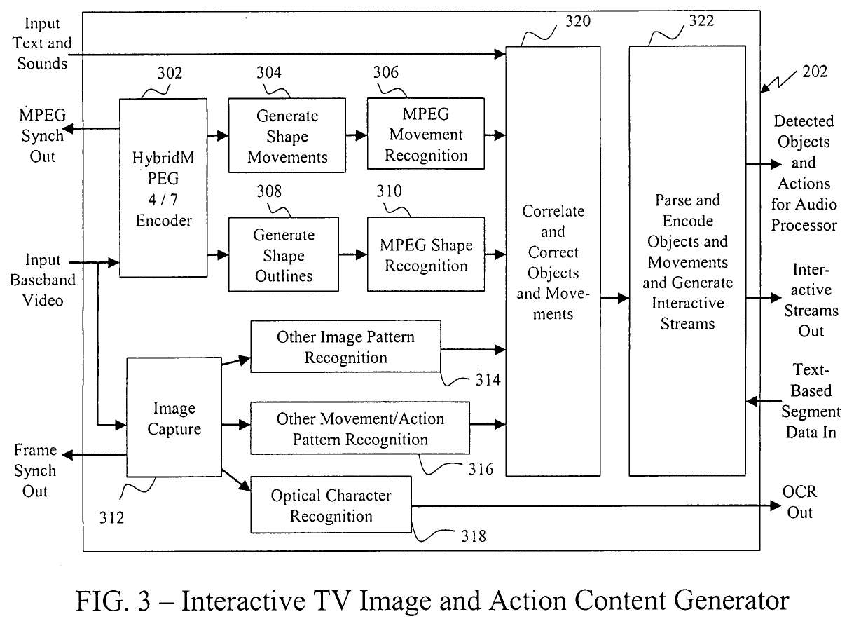

FIG.3 shows a block diagram of the image content generation subsystem 202. The input baseband video is sent to a hybrid partial MPEG4/MPEG7 encoder 302 that is used to separate the input video into objects such as background and sprites (moving objects) within that background. Unlike MPEG2 encoding, MPEG4 performs its compression based on arbitrary shapes that represent individual objects in the image. Present-day MPEG4 encoders merely isolate the objects for individual encoding. But this capability is inherently suited to the automatic isolation, recognition, and classification of objects in the image for the purposes of interactive television applications. Going beyond the mere isolation of objects, the system of the present invention accepts the isolated object shapes output by the hybrid MPEG 4/7 encoder 302 and processes the objects in a shape movement generator 304 and a shape outline generator 308. The shape movements are determined via analysis of the motion compensation and prediction elements of the encoder such as B and P frames, and this analysis is performed in the movement recognition block 306. Likewise, the actual objects in the image such as coffee cups or cars are recognized in the shape recognition block 310.

To supplement the image object and movement recognition, an additional set of processing blocks are provided which use conventional image recognition techniques from digitally captured images. The baseband video is also sent to a periodic image capture system 312, after which image pattern recognition in performed in block 314 using algorithms specific to image object pattern recognition. The captured image is also sent to a movement/action pattern recognition block 316 where actions such as drinking, running, driving, exercising, and so on are recognized.

Since the television image often also contains text characters such as news banners which flow across the bottom of the screen, news titles and summaries, signs and labels, corporate logos, and other text, the image capture system also outputs its frames to an optical character recognition system 318 which recognizes the characters, parses them, and provides them to the text and sound interactive generation system 208 as shown in FIG. 2. Likewise, the text and sound interactive generation system 208 provides text and sounds recognized in the television program to the image object and movement interactive generation system for correlation, correction, and association in block 320. Block 320 thus accepts the output of all image objects and actions, as well as recognized text and sounds in the video in order to improve accuracy of image object and action recognition and make associations and additional inferences from the composite data.

Several algorithms can be used for the detection and recognition processing performed in blocks 306, 310, 314, 316, and 318, and for the correlation and correction of objects in each stream and from one stream generation system to the other performed in block 320. Conventional pattern recognition methods can be used for initial image classification, for example: neural network systems using the least means squared method, interval arithmetic method, or feed-forward method; fuzzy logic networks; statistical decision theory methods; successive iterative calculation methods; linear discriminant analysis methods; flexible discriminant methods; tree-structured methods; Baysian belief networks; deterministic methods such as wavelet transform method and other methods that are scale invariant. For correlating and correction detections across the image and audio systems, contextual methods such as object-based representations of context and a rule based expert system can be applied, where the rules of human behavior with respect to typical purchasable objects is one example of a rule set to be used, with statistical object detection being another method using joint probability distributions of objects within a scene. Graph methods can also be used.

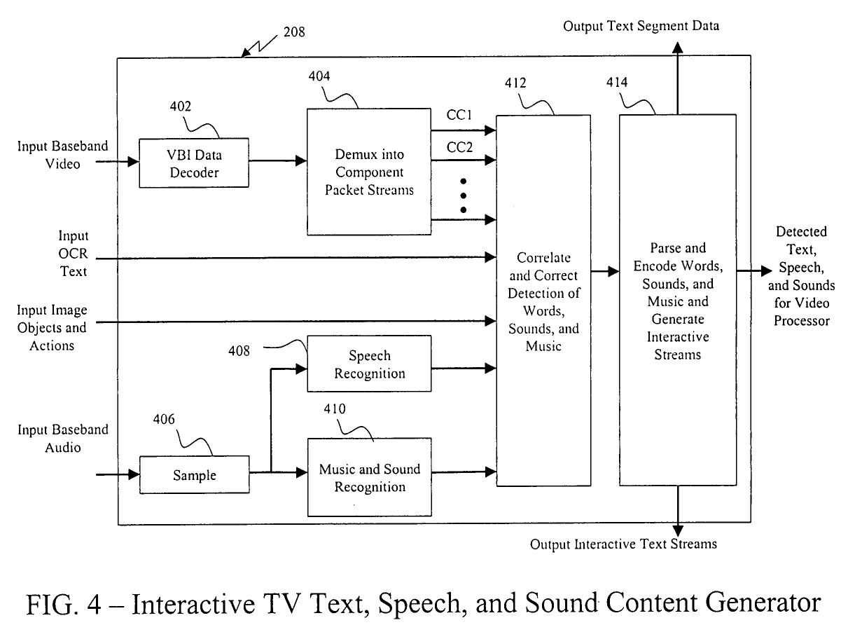

FIG. 4 depicts a block diagram of a system to generate text-, speech-, and sound-based interactive TV content associated with a television program. The baseband video is input to a vertical blanking interval (VBI) decoder 402, followed by a demultiplexer (demux) 404 that separates the VBI data into its component streams CC1, CC2, TEXT1, TEXT2, CC3, CC4, TEXT3, TEXT4, and extended data service (XDS) packets, when they exist. Program rating information for VCHIP applications can also be decoded in this system. In addition to closed caption text associated with the television program, some current interactive television applications use these data transport streams for sending interactive web links and other interactive information packets. All such legacy interactive information are thus preserved by the system of the present invention.

The baseband audio is also input to the system to a sampler 406 and the samples sent to a speech recognition block 408 and a music and other sound recognition block 410. The speech recognition block 408 permits speech in the television to be detected and packetized in case the closed captioning data is absent or errored. The music and sound recognition block 410 recognizes and classifies the presence of music and other sounds that are not speech in the television program that can be used for interactive television purposes. For example, if music is detected, the interactive system can provide music ordering options to the viewer. For the centralized implementation of the interactive television content generator, the music artist and title can be detected as well. On the other hand, if certain sounds are detected such as explosions or gun shots, the viewer can be provided with options for action/adventure games, or options to suppress violent portions of the television program.

The audio information detected from the television program is combined with Optical Character Recognition (OCR) text from the image processing block 202 and all sound related interactive information is correlated and corrected in block 412. The words, sounds, and music detected in the television program are then parsed and encoded in block 414 for interactive stream output and for providing feedback to the image stream generation block 202.

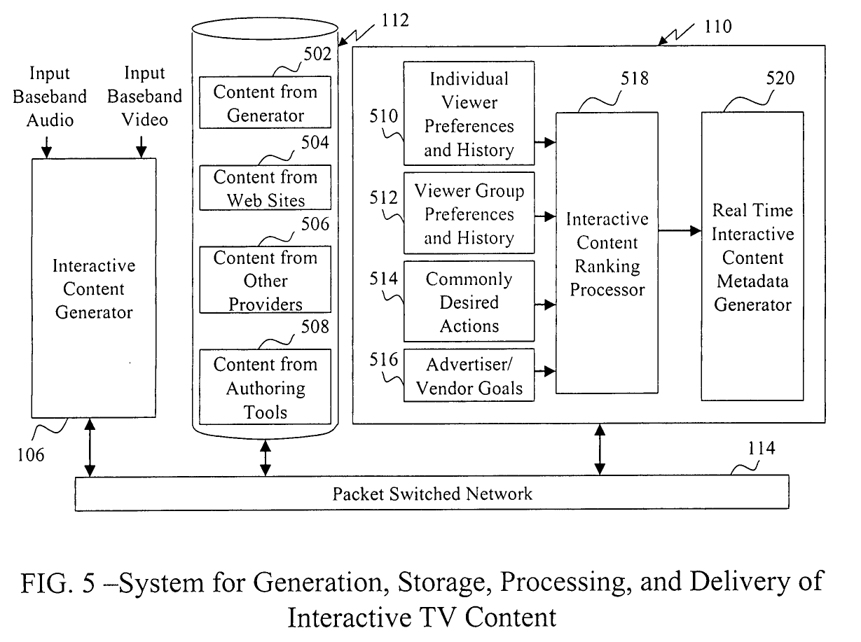

FIG. 5 depicts how interactive content generated by the generator 106 is used with other content in the interactive television libraries 112 by the content ranking and delivery system 110 to deliver interactive content to television viewers. The content 502 generated by the generator 106 is stored in the content libraries 112 along with other interactive content from web sites 504, other providers 506, and with content generated off-line from the broadcast by authoring tools 508. The content libraries contain the content itself, as well as links, tags, and timing information associated with the television programming so that the interactive content may be presented to the viewer at the right time and under the right conditions. For example, interactive content from other content providers 506 such as advertisers is stored along with key words from the advertisement content, the content generator 106 and from the authoring tools 508 so that advertisers' interactive content is provided to viewers when the television programming content or the viewers preferences and selections indicate an association is possible. In this manner, viewers will be presented with advertising when it is most opportunistic to do so, as opposed to current television programming where viewers see only the advertisements that are presented to a large number of viewers during commercial breaks. Importantly, the content from advertisers stored in 506 also contains links to purchasing opportunities or other reward, redemption or gratification options that encourage the viewer to purchase the advertisers' products.

The method by which interactive content stored in 112 is ranked and selected for viewers is shown in block 110. Individual viewer preferences and past history of interactions are stored in block 510 for purposes such as just described in order to select the optimum advertising content for viewers. These preferences and history data are derived from the interactive television integrator 120 in FIG. 1. Group viewer preferences and history stored are stored in 512 are used for similar purposes as individual viewer preferences and history so that even if an individual viewer has neither a preference or a history for a particular association, if he is similar to other viewers in other ways such that he is part of a particular viewer group, and a majority of viewers in that group do have either a preference or a history that indicates an association between that viewer group and the advertising, then the advertising can be made available to the original viewer without an individual association via the group association. A single viewer will typically be part of many viewer groups. Viewer groups are formed for a variety of reasons: similar demographics, or similar interests, or similar recent activities with the interactive television system, and so on. Viewer groups can be formed ahead of time, or can be formed in real time as a television program is being broadcast so that new interactive content can be generated or different previously generated interactive content can be provided to viewers when appropriate. Finally, the viewer group preferences and history block 512 provides a mechanism for upgrading a particular interactive content source from individualized or group-oriented to viewable by all such as conventional television advertising. When large enough numbers of viewers show an interest in interactive content, the content can be converted from a ‘pull’ oriented content to a ‘push’ oriented content. On the other hand, interactive content that was previously ‘push’ oriented can be downgraded in the same manner if a significant number of viewers are noted to skip the content, or to change channels for example. This capability provides feedback to advertisers and vendors, and also permits interactivity with viewers based on their preferences. For example, if a particular interactive content from a product vendor is about to be downgraded from push to pull, viewers can be given an opportunity to ‘choose’ to delete the commercial and either select another one from the same vendor, or to provide specific feedback on why they were uninterested in it.

Commonly desired actions 514 are also used for ranking and selection of interactive television content, such as ‘more info,’ ‘shop,’ ‘surf,’ ‘chat,’, and other actions by viewers when experiencing interactive television. Just as the viewer preferences and history are used to rank interactive content for display to viewers, when multiple choices exist for interactive content, the content associated with the most frequent viewer actions such as shopping can be ranked more highly and presented first to viewers. And of course advertiser and/or product vendor goals 516 are also used in order to rank and select interactive content to be presented or made available to viewers.

The interactive content ranking processor 518 is the method by which the plentitude of candidate interactive content is ranked and selected for transmission to the user. As with many current systems, an individual viewer can request content, and that request goes into the viewer's preferences and history block 510, with an immediate status such that the content is pulled from the library 112 and made available to the viewer. But unlike present interactive systems, the content and ranking processor 518 also provides a predictive capability, as previously described for the viewer who had no preference or history for a particular content, but nonetheless had an association with that content via a viewer group. Thus the interactive content ranking processor 518 provides the capability for interactive television viewers to receive both fully individualized content, as well as content that more general, but that is still highly relevant to the individual. As an example of the ranking processor, the viewer profile can be represented as a list of keywords indicating interests of that viewer. These keywords can be selected from a larger list by the viewer himself, or determined by monitoring viewing behaviors of the viewer. As the viewer navigates through the interactive content, he will be choosing content related to specific keywords in his profile; the more often a particular profile keyword is used, the higher ranking that is given to subsequent interactive content that is related to, or derived from that profile keyword. The highest ranking content can be presented as the default interactive content for a viewer to streamline the presentation of interactive content if desired.

The interactive content ranked and selected by the ranking processor is then distributed to viewers via the real time interactive content metadata generator 520. This generator uses the content ranking and selections of the ranking processor and the interactive content itself stored in the library 112 to package the content for delivery to viewers via their interactive TV integrator 120.

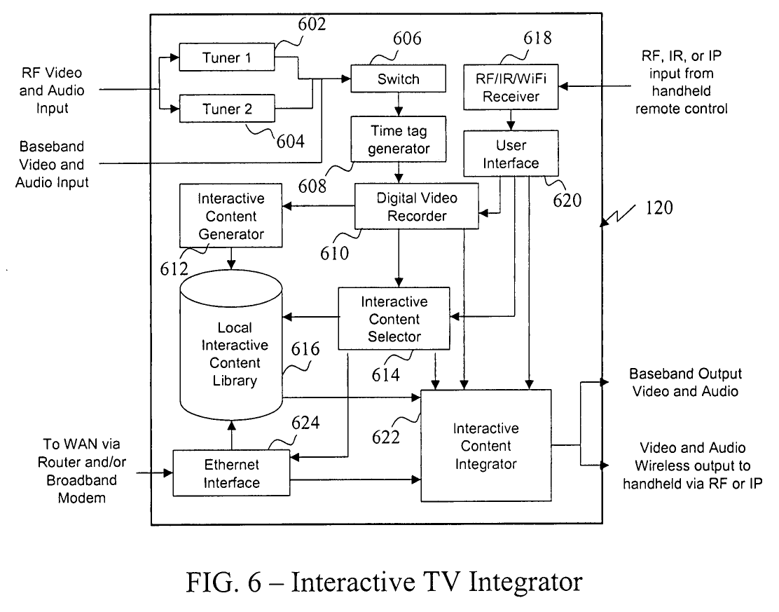

FIG. 6 shows an example interactive TV integrator that includes local versions of the interactive content generator 106, the interactive content libraries 112, and the interactive content ranking processor and selector 110. Since these versions are likely to be much smaller in scale and capability, they are renumbered as shown in the figure, but importantly, as the functions of the more capable centralized versions are migrated into the local versions, the interactive television network of the present invention has the capability to migrate from a centralized server architecture to a peer-to-peer network architecture where content can be stored primarily in customer premises, even though backups of the content will no doubt be archived centrally. Hence block 612 in the figure corresponds to block 106 previously, block 614 to block 110, and block 616 to block 112.

The RF video and audio are converted to baseband by the first tuner 602 and the second tuner 604 for passing to the switch 606. Alternately, the baseband video and audio may be input to the system directly and fed to the switch 606. Next time tags are generated from the video and audio by a time tag generator 608. The time tags are input along with the video and audio to a digital video recorder 610 for recording the television program along with time tags. The recorded digital video is provided to the interactive content generator 612, the content selector 614, and the interactive content integrator 622. The content generator works similarly to block 106 of FIG. 1, likewise the content selector is similar in function to block 110 of FIG. 1. The versions in the interactive TV integrator may have reduced functionality, however. And the interactive television content generated by 612 is sent to content libraries 616 which are similar to block 112 of FIG. 1 albeit reduced in scale, and the libraries are also fed by interactive television content received via packet switched network through the Ethernet interface 624. This Ethernet interface permits two-way, fully interactive applications to be delivered to the television viewer. For example, viewers may be offered an interactive application from an advertiser which when selected, activates a real time, two-way communications channel between the viewer (or multiple viewers) and the advertiser either directly, or via the transaction management server 109 for purposes of customer response and/or fulfillment. This real-time, two-way communications channel may be via conventional point and click, telephone conversation, videoconference, or any combination of the above. This two-way communications channel may also be implemented using conventional downstream and upstream communications channels on cable networks, for example, in which case the Ethernet interface 624 may not be necessary. Further, the real-time communications channel may be multipoint, as in a chat room, telephone conference call, or videoconference call.

The viewer controls the interactive television integrator via the electronic receiver 618, which may use RF, IR, WiFi, or any combination thereof for signaling between the remote control and the interactive television integrator. The interactive television integrator can then process viewer inputs and transmit them back to centrally located transaction management servers, interactive content selectors, and/or other content providers. This two way interactive communication channel can be used for viewer commands, voice or video telecommunications or conferencing, or for setting up viewer preferences and profiles.

The processed viewer commands are then sent to a user interface block 620 which controls the digital video recorder, the interactive content selector, and an interactive content integrator 622. The content integrator is where packet based interactive content generated locally or remotely and selected by the content selector is merged with the television programming and presented to the viewer either via baseband video and audio output, or via video and audio wireless IP streaming to a remote control, or both.

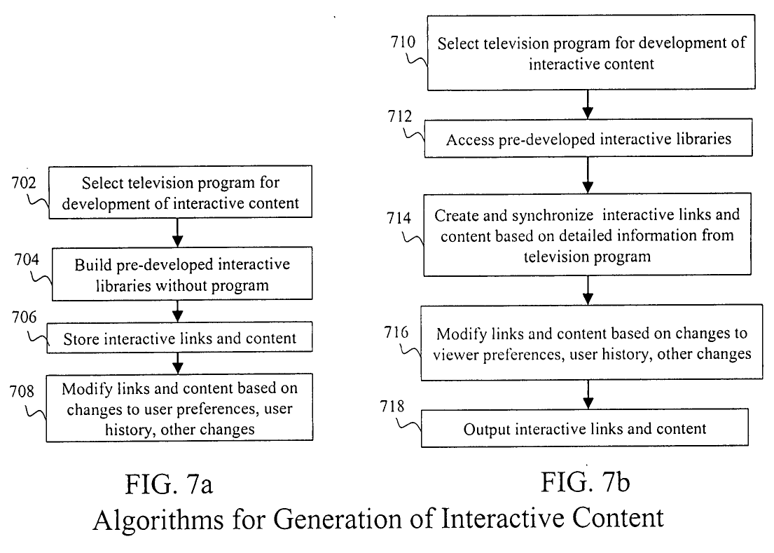

FIGS. 7a and 7b depict algorithms used for the generation of interactive content. These algorithms can be employed either in the centralized content generator, the local generator, or both. FIG. 7a depicts the algorithms used for generation of interactive content when the entire television program is not yet available. This is likely the first step in generation of interactive content for a television program. The algorithm begins with the selection of a program for which to develop interactive content 702, following which the pre-developed interactive content is developed without access to the entire television program 704. The television program material available may be limited at this stage to the title and synopsis only (as would be available via electronic program guides), or may include previews, previous episodes, similar programs, and so on. Next the interactive content and associations such as tags and links to viewer preferences, commonly desired actions, or advertiser goals are stored in the interactive libraries 706. While awaiting the actual playing or broadcast of the television program, any changes to viewer preferences, history or other changes received from viewers during use of the system for other television programming can dictate an update to the stored content 708 and associations. In this manner, the viewers' preferences and interests are completely up to date when the television program actually begins, rather than current systems where the viewer preferences and interests used to design the interactive television programming were collected days, weeks or years before.

FIG. 7b depicts the algorithms used for generation of interactive television content when the television program is available, either prior to broadcast, or during broadcast. Following selection of the television program 710, the previously developed interactive content is accessed 712 from the interactive television libraries 112. Next the synchronized interactive content is generated 714 by the interactive television content generator 106. This content and associations such as links and tags are updated and modified 716 based on new information on viewer preferences, history, advertiser goals, and so on. Finally, the updated interactive content and associations are output 718.

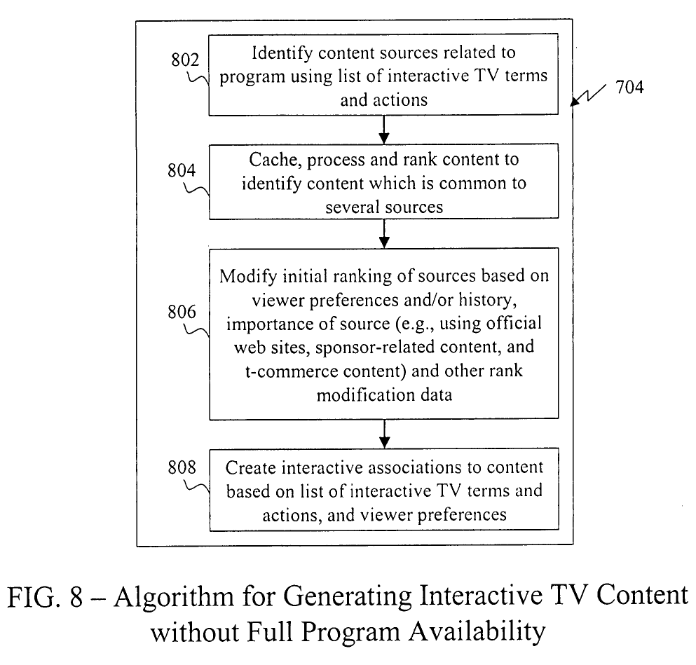

FIG. 8 shows details of the algorithm for developing interactive content without access to the entire television program, as done in block 704 of FIG. 7a. First candidate content sources are identified 802 using a list of interactive TV terms and actions. Next, the content is cached, processed and ranked 804 by identifying the content that is common to several sources or matches other previously determined viewer preferences or advertiser goals. Next, the candidate content rankings are modified 806 based on updates to viewer preferences, history, importance of the content source, and other ranking modification parameters. After this more detailed ranking is performed, associations to this ranked, interactive content are made 808 using interactive TV terms, actions, and individual or group viewer preferences. Note that these preferences are from previous viewer actions, rather than from actions during the television program of interest.

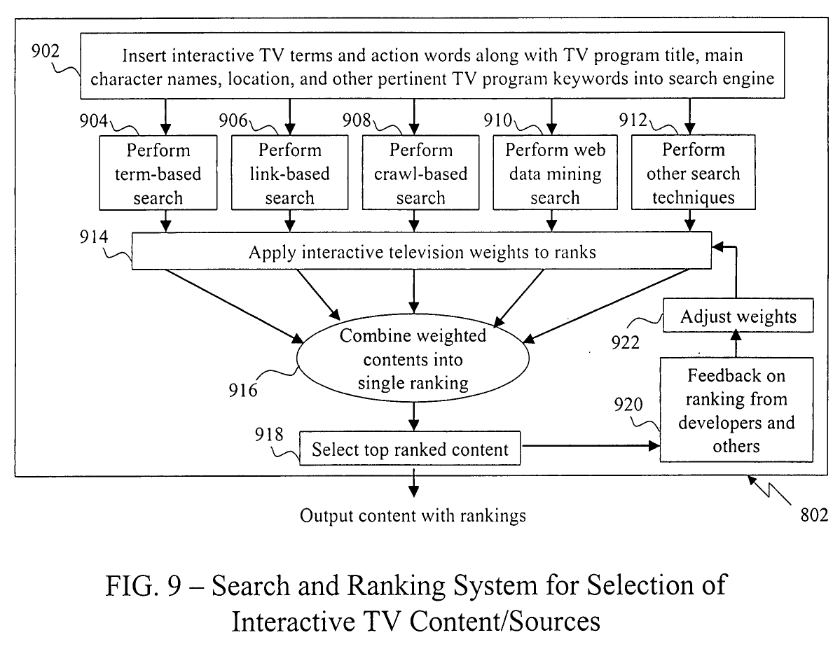

FIG. 9 shows details of the algorithms for searching and selection of interactive television content shown in block 802 of FIG. 8. The interactive television terms and actions are used, along with other data such as the TV program title, main character names, location, and other pertinent TV program keywords, as input 902 to a search engine which employs a variety of different search methods to find content. These methods include term-based searching 904, link-based searching 906, crawl-based searching 908, web data mining 910, as well as other techniques 912. Since depending on the television program content, different search methods will be optimal for the program of interest, each search result is weighted 914 by weights that can be adapted 922 based on the television program, or by other feedback 920 from interactive content developers. The weights are then combined 916 into a single ranking, for which the top ranked content can be selected 918 for distribution to viewers.

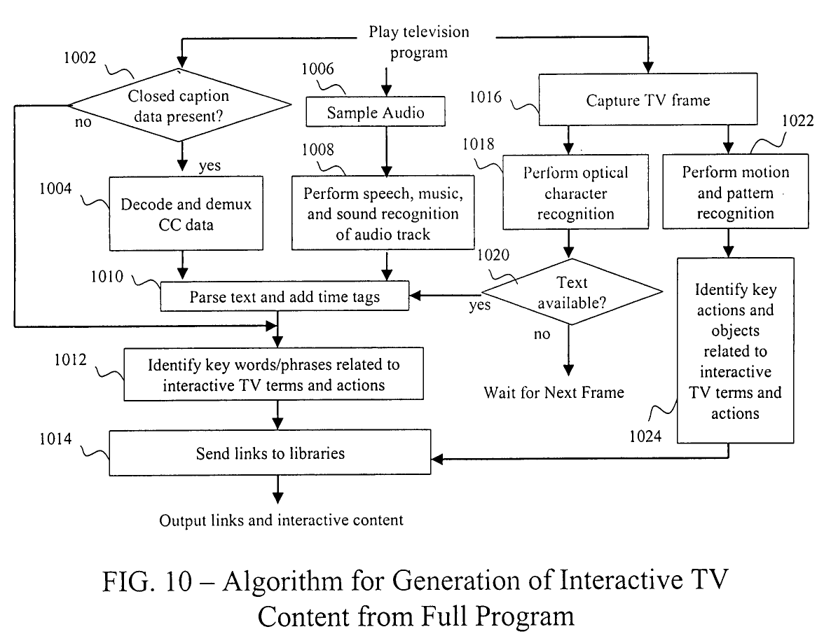

FIG. 10 shows details of the algorithms used for generation of interactive TV content using actual television program. As the television program is played or broadcast, the audio generation algorithms (on the right of FIG. 10) look for data in the vertical blanking interval (VBI) 1002 and if present, decode and demux it 1004. In case the VBI data is unavailable, and also to correct or augment it if it is present, the audio is sampled 1006 and speech recognition algorithms are applied to the sampled audio 1008. Also in 1008, the presence of music or other recognizable sounds in the audio is detected. In parallel with these tasks, the video of the television program is captured 1016 and optical character recognition (OCR) is performed 1018 along with more sophisticated motion and action and other image pattern recognition 1022. If text is identified on the screen image and output by the OCR, it is provided to be parsed and time tags added in block 1010, along with outputs of the VBI decoding and the speech, music, and sound recognition systems. Following this, keywords and/or phrases in the resulting text are identified 1012 when they relate to interactive TV terms and actions. Likewise, image objects, motions and/or actions that are related to interactive TV terms and actions are recognized in the TV videos 1024. Finally information on recognized text, music, sounds, image objects, image motions, and image actions are sent to interactive libraries 1014.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method for generating interactive content for integration with current analog or digital television programming comprising:
analysis of television programming and other interactive content related to the television programming from other content providers, web sites, and authoring tools, and generation of interactive content associated with that television programming
integration and encoding of the interactive content with the television programming
reception of integrated, encoded interactive content with televison programming in a device in the customer premises
customization of this interactive content based on dynamically defined goals of content providers and television viewers using a system of ranking the interactive content

2. The method of claim 1, wherein the analysis of television programming and other interactive content related to the television programming includes the analysis of closed caption text contained in the television programming, the analysis of text other than closed captions contained in the television programming, the analysis of image objects in the television programming, the analysis of object actions in the television programming, and includes the correlation of analysis results from closed caption text, other text contained in the television programming, image objects and object actions in the television programming in order to improve analysis performance

3. The method of claim 1, wherein the analysis of television programming and other interactive content related to the television programming uses feedback from sources other than television programming such as other content providers, and also uses feedback from viewers to improve analysis performance

4. The method of claim 1, wherein the analysis of television programming and other interactive content related to the television programming includes the use of shape and movement recognition systems to identify objects in the television programming, and also includes the use of edge and outline detection of image objects to improve the analysis performance

5. The method of claim 1, wherein the analysis of television programming and other interactive content related to the television programming includes the correlation of multiple image analysis technique results with each other to improve the analysis performance

6. The method of claim 1, wherein the analysis of television programming and other interactive content related to the television programming includes the analysis and recognition of speech in the audio track in order to improve the analysis performance, and includes the analysis and recognition of sound, music, or other non-speech information in order to improve the analysis performance, and also includes the correlation of closed caption text analysis with analysis and recognition of sound, music, or other non-speech information in order to improve the analysis performance

7. The method of claim 1, wherein the analysis of television programming and other interactive content related to the television programming includes the correlation of closed caption text and/or analysis of speech recognition outputs with image pattern recognition outputs to improve analysis performance

8. The method of claim 1, wherein the analysis of television programming and other interactive content related to the television programming includes the use of a hybrid MPEG 4/MPEG 7 encoder to identify image objects and their actions, and further uses other, non-MPEG based pattern recognition systems to correlate image object and action recognition in order to improve the analysis performance, and further uses analysis output from text and audio analysis that are correlated with image analysis to improve analysis performance.

9. The method of claim 1, wherein the generated interactive content is encoded and integrated with analog or digital television programming using a method of synchronization such that interactive content has a high correlation with the television programming at an instant of time near the moment the interactive content is made available to the viewer, and uses packetization of interactive content and transport of said packetized interactive content over a switched packet network to a home device

10. The method of claim 1, wherein the generated interactive content includes the capability for instantiation of real-time, two-way communications channels between individual viewers and content providers, between different individual viewers, and further includes the capability for instantiation of real- time, multipoint communications channels between individual viewers, other viewers, and content providers

11. The method of claim 1, wherein the generated interactive content is ranked based on a combination of individual viewer preferences and history, viewer group preferences and history, commonly desired interactive television actions, and advertiser or other content providers' or product vendors' goals for interactive television

12. The method of claim 1, wherein the generated interactive content is ranked based on individual viewer preferences and history, viewer group preferences and history, commonly desired interactive television actions, and advertiser or other content providers' or product vendors' goals for interactive television, and is used to generate metadata for transmission to a device in the customer premises

13. The method of claim 1, wherein the interactive content is generated partially in a centrally located device connected to a switched packet network and partially in a device in the customer premises connected to a switched packet network

14. The method of claim 1, wherein the interactive content is stored partially in a centrally located library connected to a packet switched network, and partially in a library located in the customer premises connected to a switched packet network

15. The method of claim 1, wherein the interactive content is stored partially in a centrally located library, and the information stored in the central library connected to a packet switched network pertains to group viewer preferences, history, and the goals of other content providers, while the information stored in a library located in the customer premises connected to a switched packet network pertains to individual viewer preferences and history, and wherein said stored and ranked interactive content is modified based on changes to user preferences or history

16. The method of claim 1, wherein the interactive content is selected partially in a centrally located server connected to a packet switched network, and partially in a computing device located in the customer premises connected to a switched packet network

17. The method of claim 1, wherein the interactive content is stored partially in a centrally located library, and the information stored in the central library connected to a packet switched network pertains to group viewer preferences, history, and the goals of other content providers, while the information stored in a library located in the customer premises connected to a switched packet network pertains to individual viewer preferences and history, and the interactive content is selected partially in a centrally located server connected to a switched packet network, and selected partially in a local computing device located in the customer premises

18. The method of claim 1, wherein the interactive content is generated by selecting television programming, building pre-developed interactive libraries, storing the links and interactive content thus generated, creating and synchronizing interactive links to television programming based on the television program itself, modifying the links and content based on changes to viewer preferences and/or history, and outputting those interactive links and content to a packet switched network for reception in devices in the customer premises that are also connected to packet switched networks

19. The method of claim 1, wherein the interactive content is generated by selecting television programming, identifying interactive content sources related to the television programming using a list of interactive television terms, and the identified interactive source content is cached, processed and ranked based on identification of content common to multiple sources, then the rankings are modified based on viewer preferences and/or history of interaction, importance of content source, and other rank modification criteria, and appropriate associations of said ranked interactive content are made with the television programming based on a list of interactive television terms and actions, as well as user preferences and profile words

20. The method of claim 1, wherein the interactive content sources are identified using a combination of term-based, link-based, crawl-based, data mining-based, and other web search engine technologies which are weighted and combined in a manner which optimizes the accuracy of content source identification results using feedback from developers, viewers and content providers to improve the ranking performance
